(19) United States
(12) Patent Application Publication
(10) Pub. No.: US 2024/0080584 A1
(43) Pub. Date: Mar. 7, 2024

(54) IMAGE SENSOR AND METHOD OF OPERATING THE IMAGE SENSOR

(71) Applicant: SK hynix Inc., Icheon-si (KR)

(72) Inventor: Hak Soon KIM, Icheon-si (KR)

(73) Assignee: SK hynix Inc., Icheon-si (KR)

(21) Appl. No.: 18/108,473

(22) Filed: Feb. 10, 2023

(30) Foreign Application Priority Data
Sep. 6, 2022 (KR) 10-2022-0113031

(51) Int. Cl. H04N 25/71; H04N 25/75

(52) U.S. Cl. CPC H04N 25/745; H04N 25/75

(57) ABSTRACT

An image sensor including a light signal generator configured to generate a plurality of light signals having different phases based on a reference light signal, a demodulated signal generator configured to generate a plurality of demodulated signals based on the reference light signal, a light source configured to sequentially output the plurality of light signals to an object, a light receiver configured to receive a plurality of reflected light signals in which the plurality of light signals are reflected from the object, and a pixel array configured to generate a plurality of pixel signals based on the plurality of demodulated signals and the plurality of reflected light signals.

### CROSS-REFERENCE TO RELATED APPLICATION

The present application claims priority under 35 U.S.C. § 119(a) to Korean patent application number 10-2022-0113031, filed on Sep. 6, 2022, in the Korean Intellectual Property Office, the entire disclosure of which is incorporated herein by reference.

### BACKGROUND

### 1. Technical Field

The present disclosure relates to an electronic device, and more particularly, to an image sensor and a method of operating the image sensor.

### 2. Related Art

Generally, an image sensor may be classified into a charge coupled device (CCD) image sensor and a complementary metal oxide semiconductor (CMOS) image sensor. Recently, the CMOS image sensor that is inexpensive to manufacture, consumes little power, and is easy to integrate with a peripheral circuit has been attracting attention.

An image sensor included in a smart phone, a tablet PC, a digital camera, or the like may convert light reflected from an external object into an electrical signal, to obtain image information on the extern& object. In order to obtain the image information, information on a depth between an object and an image sensor as well as a color is required to be obtained. A time-of-flight (TOF) method, which is one of methods of obtaining distance information from the image sensor to the object, is a method of irradiating modulated light to the object and sensing reflected and back light, to calculate the distance from a change of a phase. The TOF method has a wide application range, a high processing speed, and is advantageous in terms of a cost.

Meanwhile, a signal for modulating the light irradiated to the object and the light reflected and back may be Implemented as a square wave. In this case, in a process of processing the signal, a harmonic higher than a Nyquist frequency may cause an aliasing phenomenon, and thus a wiggling error that distorts the signal may occur.

### SUMMARY

According to an embodiment of the present disclosure, an image sensor includes a light signal generator configured to generate a plurality of light signals having different phases based on a reference light signal, a demodulated signal generator configured to generate a plurality of demodulated signals based on the reference light signal, a light source configured to sequentially output the plurality of light signals to an object, a light receiver configured to receive a plurality of reflected light signals in which the plurality of light signals are reflected from the object, and a pixel array configured to generate a plurality of pixel signals based on the plurality of demodulated signals and the plurality of reflected light signals.

According to an embodiment of the present disclosure, a method of operating an image sensor includes generating a plurality of light signals of which a phase is delayed at a regular interval, sequentially outputting the plurality of light signals to an object, receiving a plurality of reflected light signals in which the plurality of light signals are reflected from the object, generating an integrated reflected light signal obtained by summing the plurality of reflected light signals, and demodulating the integrated reflected light signal.

According to an embodiment of the present disclosure, an image processing system includes an image sensor configured to sequentially output a plurality of light signals having different phases to an object, receive a plurality of reflected light signals in which the plurality of light signals are reflected from the object, generate a plurality of pixel signals based on a plurality of demodulated signals and the plurality of reflected light signals, and generate image data based on the plurality of pixel signals, and an image processing device configured to perform an operation of processing the image data.

### BRIEF DESCRIPTION OF THE DRAWINGS

FIG. 1 is a diagram illustrating an image sensor according to an embodiment of the present disclosure.

FIG. 2 is a diagram illustrating a plurality of light signals according to an embodiment of the present disclosure.

FIG. 3 is a diagram illustrating an integrated reflected light signal according to an embodiment of the present disclosure.

FIG. 4 is a diagram illustrating a plurality of demodulated signals according to an embodiment of the present disclosure.

FIGS. 5A, 5B, 5C, and 5D are diagrams each illustrating a correlation signal according to an embodiment of the present disclosure.

FIG. 6 is a diagram illustrating a wiggling error according to an embodiment of the present disclosure.

FIG. 7 is a diagram illustrating a signal of which a duty cycle is adjusted according to an embodiment of the present disclosure.

FIG. 8 is a diagram illustrating a wiggling error according to an embodiment of the present disclosure.

FIGS. 9A and 9B are diagrams illustrating an improvement degree of a wiggling error according to an embodiment of the present disclosure.

FIG. 10 is a flowchart illustrating a method of operating an image sensor according to an embodiment of the present disclosure,

FIG. 11 is a block diagram illustrating an electronic device including an image processing system according to an embodiment of the present disclosure.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and the descriptions are not limited to the embodiments described in the present specification or application.

An embodiment of the present disclosure provides an image sensor and a method of operating the image sensor capable of reducing a wiggling error.

According to the present technology, in an embodiment, an image sensor and a method of operating the image sensor capable of reducing a wiggling error may be provided

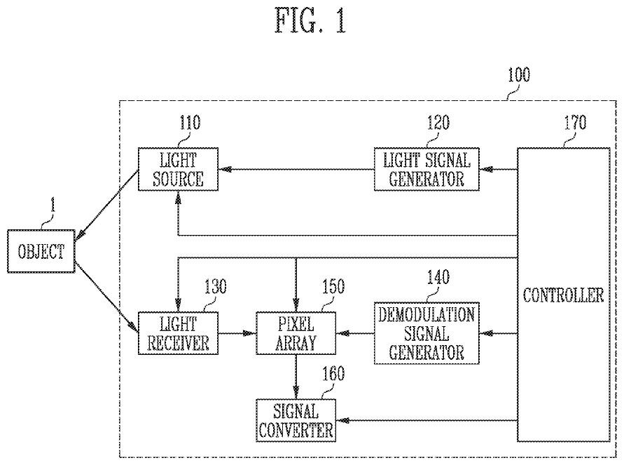

FIG. 1 is a diagram illustrating an image sensor according to an embodiment of the present disclosure.

Referring to FIG. 1, the image sensor 100 may obtain mage data corresponding to depth information (or a depth image) of an object 1 using a time of flight (ToF) technique. A ToF method may be largely classified into a direct method and an in-direct method. Although a principle of calculating a distance using irradiated light and reflected and back light is common in the direct method and the in-direct method, the ToF method may be classified according to a measurement method.

In a case of the direct method, the distance is measured by calculating a round trip time, and in a case of the in-direct method, the distance is measured using a phase difference. The direct method is advantageous for long-distance measurement and is used in an automobile or the like, and the in-direct method is used in a game machine, a mobile camera, and the like that requires a shorter distance and a higher processing speed. The in-direct method has an advantage that a circuit is simple and relatively inexpensive compared to the direct method. The image sensor 100 according to an embodiment of the present disclosure may be a sensor using the in-direct method.

The image sensor 100 includes a light source 110, a light signal generator 120, a light receiver 130, a demodulated signal generator 140, a pixel array 150, a signal converter 160, and a controller 170.

The light source 110 may irradiate a light signal to the object 1. The light source 110 may be a laser diode (LD) or a light emitting diode (LED) that emits light (for example, near infrared light, infrared light, or visible light) of a specific wavelength band, a near infrared laser (NIR), a point light source, a monochromatic illumination source in which a white lamp and a monochromator are combined, or a combination of other laser light sources. For example, the light source 110 may be infrared light having a wavelength of 800 nm to 1000 nm. The light signal irradiated from the light source 110 may be a modulated light signal modulated with a predetermined frequency. Although only one light source 110 is shown in FIG. 1 for convenience of description, the image sensor 100 may include a plurality of light sources according to an embodiment. The word “predetermined” as used herein with respect to a parameter, such as a predetermined frequency, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

The light source 110 may output a plurality of light signals generated by the light signal generator 120. The plurality of light signals may be signals of which a phase is shifted at a regular interval based on a reference light signal.

In an embodiment, the light source 110 may sequentially output each of the plurality of light signals according to a regular time interval during an integration time. At this time, the integration time may be a time used for the pixel array 150 to output an electrical charge corresponding to the reflected light signal as a pixel signal. The light source 110 may periodically output the plurality of light signals.

In an embodiment, the light source 110 may output the plurality of light signals in a time division method. The light source 110 may sequentially output the plurality of light signals by temporally dividing the integration time.

The light signal generator 120 may generate a plurality of light signals having different phases based on the reference light signal.

In an embodiment, the plurality of light signals may have the same amplitude and period. In addition, the plurality of light signals may be signals modulated with a predetermined frequency.

In an embodiment, the light signal generator 120 may generate the plurality of light signals by delaying a phase of the reference light signal several times according to a regular interval.

In an embodiment, the plurality of light signals may have a duty cycle of less than 50%. For example, the light signal generator 120 may adjust the duty cycle of the plurality of light signals to be less than 50%.

The light receiver 130 may receive a plurality of reflected light signals in which the plurality of light signals are reflected from the object 1.

In an embodiment, the light receiver 130 may remove noise caused due to ambient light or the like from the plurality of reflected light signals.

In an embodiment, the light receiver 130 may generate an integrated reflected light signal obtained by summing the plurality of reflected light signals received during the integration time.

The demodulated signal generator 140 may generate a plurality of demodulated signals based on the reference light signal.

In an embodiment, the demodulated signal generator 140 may generate the plurality of demodulated signals by delaying the phase of the reference light signal by 0°, 90°, 180°, and 270°. That is, the plurality of demodulated signals may be signals in which the phase of the reference light signal is shifted by 0°, 90°, 180°, and 270°, respectively.

In an embodiment, the plurality of demodulated signals may have a duty cycle of less than 50%. That is, the duty cycle of the plurality of demodulated signals may be the same as the duty cycle of the plurality of light signals. For example, the demodulated signal generator 140 may adjust the duty cycle of the plurality of demodulated signals to be less than 50%.

The pixel array 150 may include a plurality of pixels successively arranged in a two-dimensional matrix structure (for example, successively arranged in a column direction and a row direction). A pixel may be a minimum unit in which the same shape is repeatedly arranged on a pixel array.

In an embodiment, each of the plurality of pixels may be a pixel having a 2-tap structure. For example, each of the plurality of pixels may include an in-phase receptor and an out-phrase receptor. The light source 110 may output light while flickering at a fast interval. In this case, the in-phase receptor may be activated to sense light only during an in-phase, that is, the light source 110 is in an on state. The out-phase receptor may be activated only during an out-phase, that is, the light source 110 is in an off state. However, this is merely an example, and a structure of the plurality of pixels may be variously set.

In an embodiment, each of pixels may include a plurality of sub-pixels. The sub-pixels may be arranged in a matrix structure to form a unit pixel.

The pixels may be formed on a semiconductor substrate or an epitaxial layer, and each unit pixel may output a pixel signal by converting incident light incident through the light receiver 130 into an electrical signal corresponding to intensity of the light. At this time, the pixel signal may be a signal indicating a distance to the object 1.

A region in which pixels are positioned on the pixel array 150 may be referred to as a sensing region. Pixels positioned in the sensing region may output the pixel signal by converting the incident light into the electric signal corresponding to the intensity of the incident light.

The pixel array 150 may include a bias field region positioned along an edge of the sensing region. The bias field region may be formed on a semiconductor substrate or an epitaxial layer, and the controller 170 may adjust the pixel signal output by the pixel by adjusting a voltage applied to the bias field region.

In an embodiment, the pixel array 150 may generate a plurality of pixel signals based on the plurality of demodulated signals and the plurality of reflected light signals. For example, the pixel array 150 may generate the plurality of pixel signals by demodulating the integrated reflected light signal formed by the plurality of reflected light signals. Specifically, the pixel array 150 may generate the plurality of pixel signals by sampling the integrated reflected light signal based on the plurality of demodulated signals.

The signal converter 160 may generate the image data corresponding to the depth information indicating the distance to the object 1 based on the plurality of pixel signals. For example, the signal converter 160 may convert the plurality of pixel signals from an analog signal to a digital signal, and generate the depth information by calculating the converted signal.

A time delay according to the distance between the image sensor 100 and the object 1 may exist between the modulated light output from the light source 110 and the incident light received through the light receiver 130. Such a time delay may appear as a phase difference between the pixel signal and the light signal output through the light source 110. The signal converter 160 may generate the image data corresponding to the depth information by calculating the phase difference.

In an embodiment, the signal converter 160 may include a correlated double sampler that performs correlated double sampling (CDS) on the pixel signals output from the pixel array 150. In addition, the signal converter 160 may include an analog-to-digital converter (ADC) that converts a signal output from the correlated double sampler into a digital signal. In addition, the signal converter 160 may include a buffer that temporarily stores the digital signal output from the ADC and outputs the digital signal to an outside under control of the controller 170.

The controller 170 may control the light source 110, the light signal generator 120, the light receiver 130, the demodulated signal generator 140, the pixel array 150, and the signal converter 160. For example, the controller 170 may generate a clock signal for controlling the light source 110, the light signal generator 120, the light receiver 130, the demodulated signal generator 140, the pixel array 150, and the signal converter 160.

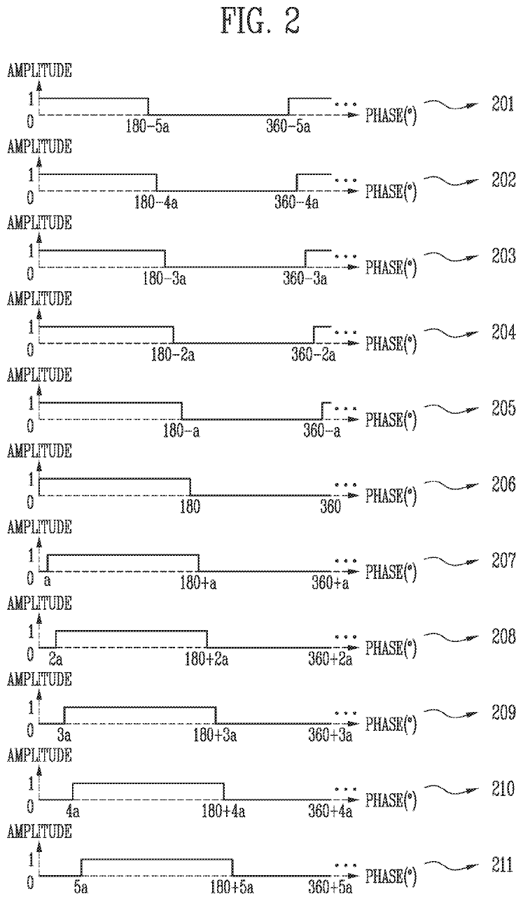

FIG. 2 is a diagram illustrating a plurality of light signals according to an embodiment of the present disclosure.

Referring to FIG. 2, the light signal generator 120 may generate a plurality of light signals 201 to 211 of which a phase is delayed at a regular interval. For example, the light signal generator 120 may generate the plurality of light signals 201 to 211 by delaying a phase of a reference light signal 206 several times at a regular interval. That the phase is delayed at the regular interval may have the same meaning as that the phase is shifted at the regular interval.

The reference light signal 206 may be a square wave. For example, the reference light signal 206 may be a signal in which a waveform having an amplitude of 1 from a phase of 0° to 180° and an amplitude of 0 from a phase of 180° to 360° is periodically repeated.

The light signal generator 120 may generate the plurality of light signals by shifting the phase of the reference light signal 206 at an a° interval. For example, the light signal generator 120 may generate the light signal 205 in which the phase of the reference light signal 206 is shifted by −a°, the light signal 204 in which the phase of the reference light signal 206 is shifted by −2a°, the light signal 203 in which the phase of the reference light signal 206 is shifted by −3a°, the light signal 202 in which the phase of the reference light signal 206 is shifted by −4a°, and the light signal 201 in which the phase of the reference light signal 206 is shifted by −5a°. In addition, the light signal generator 120 may generate the light signal 207 in which the phase of the reference light signal 206 is shifted by a°, the light signal 208 in which the phase of the reference light signal 206 is shifted by 2a°, the light signal 209 in which the phase of the reference light signal 206 is shifted by 3a°, the light signal 210 in which the phase of the reference light signal 206 is shifted by 4a°, and the light signal 211 in which the phase of the reference light signal 206 is shifted by 5a°.

The plurality of light signals 201 to 211 may be signals having the same amplitude and period and different phases.

Meanwhile, in FIG. 2, the phase of the reference light signal 206 is shifted 10 times to generate a total of 11 light signals, but the present disclosure is not limited thereto, According to an embodiment, the number of times the phase of the reference light signal 206 is shifted, a shift interval, a shift range, and the like may be various according to an embodiment,

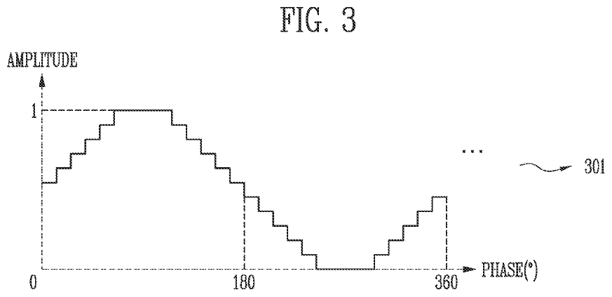

FIG. 3 is a diagram illustrating an integrated reflected light signal according to an embodiment of the present disclosure.

Referring to FIG. 3, the light receiver 130 may generate an integrated reflected light signal 301 by summing the plurality of reflected light signals. The plurality of reflected light signals may correspond to the plurality of light signals, respectively. A phase of the plurality of reflected light signals may be changed according to the distance to the object 1 compared to the plurality of light signals.

In an embodiment, the light receiver 130 may sum up the plurality of reflected light signals and adjust an amplitude of the summed signals to be the same as an amplitude of the reference light signal 206. Accordingly, the integrated reflected light signal 301 may have the same amplitude as the plurality of light signals 201 to 211. Accordingly, the integrated reflected light signal 301 may have a shape similar to a triangular wave.

Meanwhile, the integrated reflected light signal 301 shown in FIG. 3 is for describing a signal shape, and the phase of the integrated reflected light signal 301 may be determined by the distance to the object.

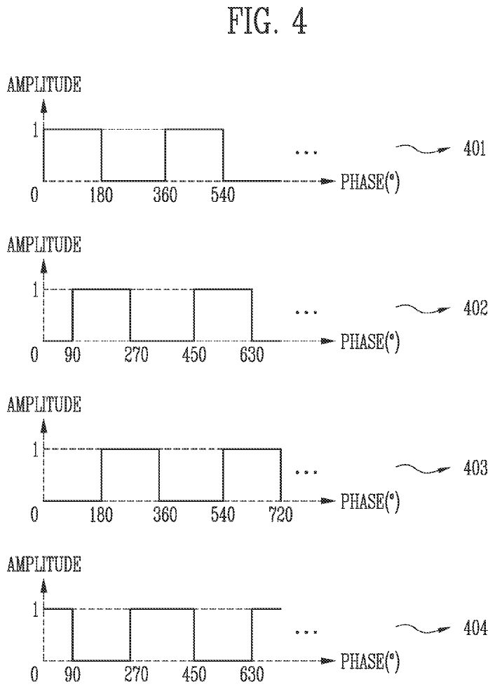

FIG. 4 is a diagram illustrating a plurality of demodulated signals according to an embodiment of the present disclosure.

Referring to FIG. 4, the demodulated signal generator 140 may generate a plurality of demodulated signals 401 to 404 by delaying the phase of the reference light signal 206 by 0°, 90°, 180°, and 270°. The plurality of demodulated signals 401 to 404 may have the same amplitude and period as the reference light signal 206. The plurality of demodulated signals 401 to 404 may be applied to the pixel array 150 and used to demodulate the integrated reflected light signal 301.

Meanwhile, four demodulated signals are described with reference to FIG. 4, but the present disclosure is not limited thereto, and the number of demodulated signals may be variously set according to an embodiment.

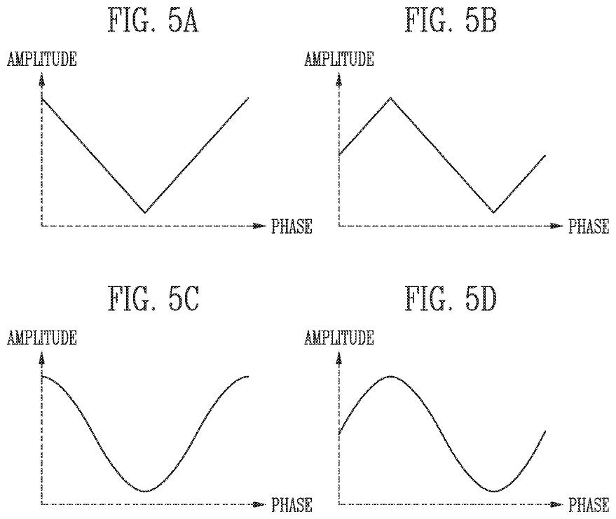

FIGS. 5A to 5D are a diagram illustrating a correlation signal according to an embodiment of the present disclosure.

FIG. 5A is a graph illustrating a correlation signal between the reflected light signal received in the in-phase and the plurality of demodulated signals 401 to 404 according to the prior art. FIG. 5B is a graph illustrating a correlation signal between the reflected light signal received in the out-phase and the plurality of demodulated signals 401 to 404 according to the prior art. At this time, the prior art may indicate a method of outputting only the reference light signal to the object. FIG. 5C is a graph illustrating a correlation signal between the integrated reflected light signal 301 received in the in-phase and the plurality of demodulated signals 401 to 404 according to the present disclosure. FIG. 5D is a graph illustrating a correlation signal between the integrated reflected light signal 301 received in the out-phase and the plurality of demodulated signals 401 to 404 according to the present disclosure.

Referring to FIGS. 5A to 5D, the correlation signal may indicate a cross correlation signal. In an embodiment, the correlation signal may be a signal indicating a cross correlation between the reflected light signal and the demodulated signal. For example, the correlation signal may be indicated by sampling between the reflected light signal and the demodulated signal.

Here, as shown in FIGS. 5A and 5B, the correlation signals according to the prior art may appear in a form of a triangular wave. In this case, as will be described later, a wiggle error may increase. In contrast, as shown in FIGS. 5C and 5D, the correlation signals according to the present disclosure may appear in a form of a trigonometric function such as sine or cosine. In this case, as will be described later, the wiggling error may be reduced,

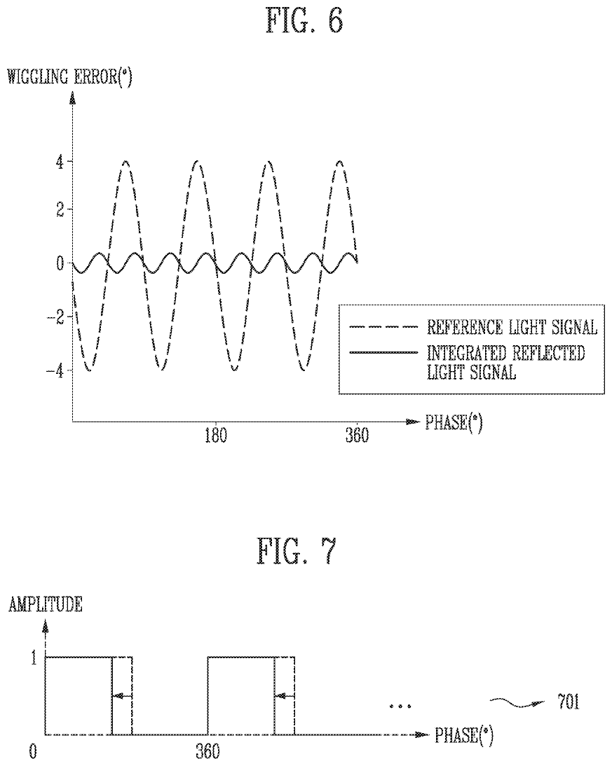

FIG. 6 is a diagram illustrating a wiggling error according to an embodiment of the present disclosure.

Referring to FIG. 6, a dotted line in a graph indicates a wiggling error generated according to a comparative example. A solid line in the graph indicates a wiggling error generated according to the present disclosure. Here, the comparative example means that only the reference light signal, which is a square wave, is output to the object, and then the correlation signal between the reflected light signal and the demodulated signal is generated. The present disclosure means that the plurality of light signals are output to the object, and then the correlation signal between the integrated reflected light signal and the demodulated signal is generated. In an embodiment, the present disclosure described with reference to FIG. 6 may indicate an embodiment in which a phase shift interval between the plurality of light signals is 11.25° and a duty cycle is 50%. At this tune, the higher the wiggling error, the more severe a signal distortion.

For example, the wiggle error generated according to the comparative example may have a range of approximately +4° to −4°. On the other hand, the wiggle error generated according to an embodiment of the present disclosure may have a range approximately +0.334° to −0.334°. Accordingly, in an embodiment of the present disclosure, the wiggle error may be improved by about 12 times compared to the comparative example.

FIG. 7 is a diagram illustrating a signal of which a duty cycle is adjusted according to an embodiment of the present disclosure.

Referring to FIG. 7, the light signal generator 120 may adjust the duty cycle of the plurality of light signals to be less than 50%. For example, the light signal generator 120 may adjust the duty cycle of the reference light signal to be less than 50%. In this case, in reference light signal 701 of which the duty cycle is adjusted, a range of a phase having an amplitude of 1 may be less than a range of a phase having an amplitude of 0. Thereafter, the light signal generator 120 may generate the plurality of light signals by delaying a phase of the reference light signal 701 of which the duty cycle is adjusted at a regular interval. Accordingly, the plurality of light signals may also have a duty cycle of less than 50%.

In addition, the demodulated signal generator 140 may adjust a duty cycle of the plurality of demodulated signals to be less than 50%. For example, the demodulated signal generator 140 may generate the plurality of demodulated signals by delaying the phase of the reference light signal 701, of which duty cycle is adjusted, by 0°, 90°, 180°, and 270°. Accordingly, the plurality of demodulated signals may also have the duty cycle of less than 50%. As a result, the plurality of light signals and the plurality of demodulated signals may have the same duty cycle.

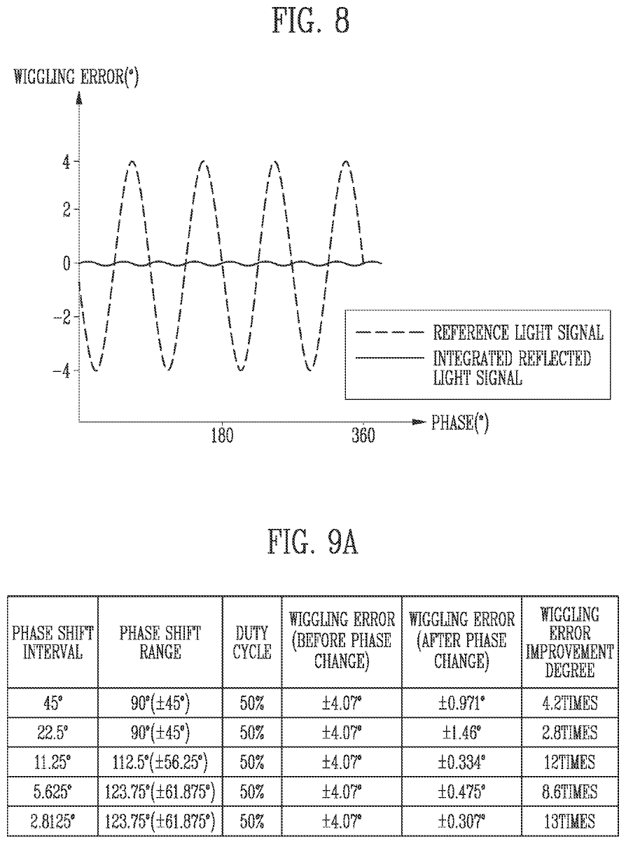

FIG. 8 is a diagram illustrating a wiggling error according to an embodiment of the present disclosure.

Referring to FIG. 8, a dotted line in a graph indicates a wiggling error generated according to a comparative example. A solid line in the graph indicates a wiggling error generated according to the present disclosure. Here, the comparative example means that a case in which only the reference light signal, which is a square wave, is output to the object, and then the correlation signal between the reflected light signal and the demodulated signal is generated, and the duty cycle is 50%. The present disclosure means a case in which the plurality of light signals are output to the object, and then the correlation signal between the integrated reflected light signal and the demodulated signal is generated, and the duty cycle of the plurality of light signals and the plurality of demodulated signals is less than 50%. In an embodiment, the present disclosure described with reference to FIG. 8 may indicate an embodiment in which a phase shift interval between the plurality of light signals is 11.25° and the duty cycle is 45 k.

For example, the wiggle error generated according to the comparative example may have a range of approximately +4° to −4°. On the other hand, the wiggle error generated according to an embodiment of the present disclosure may have a range of approximately +0.0815° to −0.0815°. Accordingly, in an embodiment of the present disclosure, the wiggle error may be improved by about 50 times compared to the comparative example.

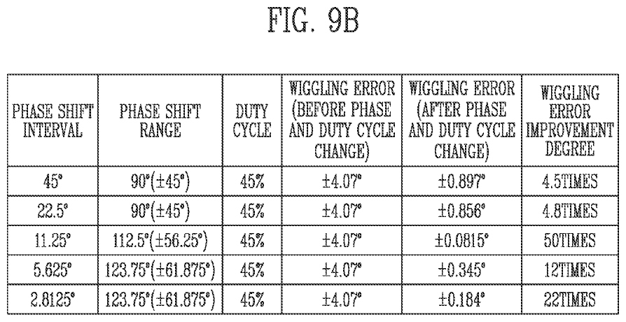

FIGS. 9A and 9B are diagrams illustrating an improvement degree of a wiggling error according to an embodiment of the present disclosure.

Specifically, FIG. 9A is a table illustrating, in an embodiment, a degree to which the wiggle error is improved according to a phase shift of the plurality of light signals.

In an embodiment, FIG. 9A illustrates each wiggle error improvement when the phase shift interval is any one of 2.8125°, 5.625°, 11.25° 22.5°, or 45°, and the duty cycle is 50%. When the phase shift interval is 2.8125° or 5.625°, the plurality of light signals may have a phase shift range from −61.875° to +67.875°. In addition, when the phase shift interval is 11.25°, the plurality of light signals may have a phase shift range from −56.25° to +56.25° In addition, when the phase shift interval is 22.5° or 45°, the plurality of light signals may have a phase shift range from −45° to +45°.

Referring to FIG. 9A, in an embodiment, the improvement of the wiggling error is the highest when the phase shift interval between the plurality of light signals among five phase shift intervals is 2.8125°, and the improvement of the wiggling error is the second highest when the phase shift interval is 11.25°.

FIG. 9B is a table illustrating, in an embodiment, a degree to which the wiggle error is improved according to adjustment of the phase shift and the duty cycle of the plurality of light signals.

In an embodiment, FIG. 9B illustrates each wiggle error improvement when the phase shift interval is any one of 2.8125°, 5.625°, 11.25° 22.5°, or 45°, and the duty cycle is 45%. That is, FIG. 9B may indicate an example in which the duty cycle is changed from 50% to 45% compared to FIG. 9A.

Referring to FIG. 9B, in an embodiment, when the phase shift interval between the plurality of light signals among the five phase shift intervals is 11.25° and the duty cycle is set to 45%, the improvement degree of the wiggle error is the highest.

Accordingly, according to an embodiment of the present disclosure, the wiggling error may be reduced by outputting the plurality of light signals having different phases and generating the pixel signals based on the plurality of reflected light signals reflected from the object.

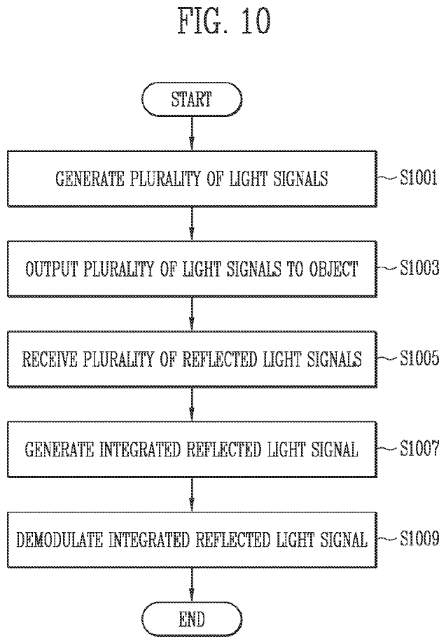

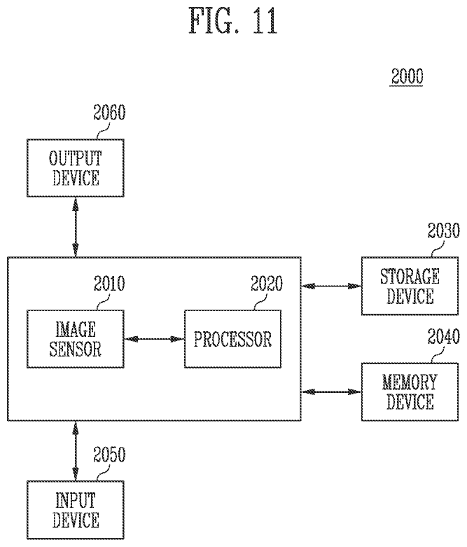

FIG. 10 is a flowchart illustrating a method of operating an image sensor according to an embodiment of the present disclosure.

The method shown in FIG. 10 may be performed by, for example, the image sensor 100 shown in FIG. 1.

Referring to FIG. 10, in step S1001, the image sensor 100 may generate the plurality of light signals of which the phase is delayed at the regular interval. At this time, the image sensor 100 may generate the plurality of light signals by delaying the phase of the reference light signal several times at the regular interval.

In step S1003, the image sensor 100 may sequentially output the plurality of light signals to the object. At this time, the image sensor 100 may temporally divide and output the plurality of light signals during the integration time.

In step S1005, the image sensor 100 may receive the plurality of reflected light signals in which the plurality of light signals are reflected from the object.

In step S1007, the image sensor 100 may generate the integrated reflected light signal obtained by summing the plurality of reflected light signals.

In step S1009, the image sensor 100 may demodulate the integrated reflected light signal. For example, the image sensor 100 may generate the plurality of demodulated signals based on the reference light signal among the plurality of light signals. Thereafter, the image sensor 100 may demodulate the integrated reflected light signal by sampling the integrated reflected light signal based on the plurality of demodulated signals. Accordingly, the image sensor 100 may generate the pixel signals in which the wiggle error is reduced,

FIG. 11 is a block diagram illustrating an electronic device including an image processing system according to an embodiment of the present disclosure.

Referring to FIG. 11, the electronic device 2000 may include an image sensor 2010, a processor 2020, a storage device 2030, a memory device 2040, an input device 2050, and an output device 2060. Although not shown in FIG. 11, the electronic device 2000 may further include ports capable of communicating with a video card, a sound card, a memory card, a USB device, or the like, or communicating with other electronic devices.

The image sensor 2010 may generate image data corresponding to incident light. The image data may be transferred to and processed by the processor 2020. The output device 2060 may display the image data. The storage device 2030 may store the image data. The processor 2020 may control operations of the image sensor 2010, the output device 2060, and the storage device 2030.

In an embodiment, the image sensor 2010 may perform the operations of the image sensor 100 described with reference to FIG. 1.

For example, the image sensor 2010 may output a plurality of light signals having different phases to an object. The image sensor 2010 may receive a plurality of reflected light signals in which a plurality of light signals are reflected from the object, and may generate an integrated reflected light signal formed by the plurality of reflected light signals. The image sensor 2010 may generate a plurality of pixel signals based on the integrated reflected light signal and a plurality of demodulated signals, and may output the image data based on the plurality of pixel signals.

The processor 2020 may be an image processing device that performs an operation of processing the image data received from the image sensor 2010 and outputs the processed image data. Here, the processing may be electronic image stabilization (EIS), interpolation, color tone correction, image quality correction, size adjustment, or the like.

The processor 2020 may be implemented as a chip independent of the image sensor 2010. For example, the processor 2020 may be implemented as a multi-chip package. In another embodiment of the present disclosure, the processor 2020 may be included as a part of the image sensor 2010 and implemented as a single chip.

The processor 2020 may execute and control an operation of the electronic device 2000. According to an embodiment of the present disclosure, the processor 2020 may be a microprocessor, a central processing unit (CPU), or an application processor (AP). The processor 2020 may be connected to the storage device 2030, the memory device 2040, the input device 2050, and the output device 2060 through an address bus, a control bus, and a data bus to perform communication.

The storage device 2030 may include a flash memory device, a solid state drive (SSD), a hard disk drive (HDD), a CD-ROM, all types of nonvolatile memory devices, and the like.

The memory device 2040 may store data required for the operation of the electronic device 2000. For example, the memory device 2040 may include a volatile memory device such as a dynamic random access memory (DRAM) or a static random access memory (SRAM) and a nonvolatile memory device such as an erasable programmable read-only memory (EPROM), an electrically erasable programmable read-only memory (EEPROM), and a flash memory device. The processor 2020 may execute a command set stored in the memory device 2040 to control the image sensor 2010 and the output device 2060.

The input device 2050 may include an input means such as a keyboard, a keypad, and a mouse, and the output device 2060 may include an output means such as a printer device and a display.

The image sensor 2010 may be implemented as various types of packages. For example, at least some configurations of the image sensor 2010 may be implemented by using packages such as a package on package (PoP), ball grid arrays (BGAs), chip scale packages (CSPs), plastic leaded chip carriers (PLCC), a plastic dual in line package (PDIP), a die in waffle pack, die in wafer form, a chip on board (COB), a ceramic dual in line package (CERDIP), a metric quad flat package (MQFP), a thin quad flat package (TQFP), a small outline integrated circuit (SOIC), a shrink small outline package (SSOP), a thin small outline package (TSOP), a system in package (SIP), a multi-chip package (MCP), a wafer-level fabricated package (WFP), or a wafer-level processed stack package (WSP).

Meanwhile, the electronic device 2000 may be interpreted as all computing systems using the image sensor 2010. The electronic device 2000 may be implemented in a form of a packaged module, a part, or the like. For example, the electronic device 2000 may be implemented as a digital camera, a mobile device, a smart phone, a personal computer (PC), a tablet personal computer (PC), a notebook computer, a personal digital assistant (PDA), an enterprise digital assistant (EDA), a portable multimedia player (PMP), a wearable device, a black box, a robot, an autonomous vehicle, or the like.

What is claimed is:

1. An image sensor comprising:
a light signal generator configured to generate a plurality of light signals having different phases based on a reference light signal;
a demodulated signal generator configured to generate a plurality of demodulated signals based on the reference light signal;
a light source configured to sequentially output the plurality of light signals to an object;
a light receiver configured to receive a plurality of reflected light signals in which the plurality of light signals are reflected from the object; and
a pixel array configured to generate a plurality of pixel signals based on the plurality of demodulated signals and the plurality of reflected light signals.

2. The image sensor of claim 1, wherein the plurality of light signals include the same amplitude and period.

3. The image sensor of claim 1, wherein the light signal generator delays a phase of the reference light signal at least one time according to a regular interval to generate the plurality of light signals.

4. The image sensor of claim 1, wherein the light source sequentially outputs each of the plurality of light signals according to a regular time interval during an integration time.

5. The image sensor of claim 1, wherein the demodulated signal generator delays a phase of the reference light signal by 0°, 90°, 180°, and 270° to generate the plurality of demodulated signals.

6. The image sensor of claim 1, wherein the light receiver generates an integrated reflected light signal obtained by summing the plurality of reflected light signals received during an integration time.

7. The image sensor of claim 6, wherein the pixel array generates the plurality of pixel signals by sampling the integrated reflected light signal based on the plurality of demodulated signals.

8. The image sensor of claim 1, wherein the plurality of light signals and the plurality of demodulated signals have a duty cycle of less than 50%.

9. A method of operating an image sensor, the method comprising:
generating a plurality of light signals of which a phase is delayed at a regular interval;
sequentially outputting the plurality of light signals to an object;
receiving a plurality of reflected light signals in which the plurality of light signals are reflected from the object;
generating an integrated reflected light signal obtained by summing the plurality of reflected light signals; and
demodulating the integrated reflected light signal.

10. The method of claim 9, wherein generating the plurality of light signals comprises generating the plurality of light signals by delaying a phase of a reference light signal at least one time according to the regular interval.

11. The method of claim 9, wherein outputting comprises dividing the plurality of light signals and outputting during an integration time.

12. The method of claim 9, further comprising:
generating a plurality of demodulated signals based on a reference light signal.

13. The method of claim 12, wherein generating the plurality of demodulated signals comprises generating the plurality of demodulated signals by delaying a phase of the reference light signal by 0°, 90°, 180°, and 270°.

14. The method of claim 12, wherein demodulating comprises sampling the integrated reflected light signal based on the plurality of demodulated signals.

15. The method of claim 12, further comprising:
adjusting a duty cycle of the plurality of light signals and the plurality of demodulated signals to be less than 50%.

16. An image processing system comprising:
an image sensor configured to sequentially output a plurality of light signals having different phases to an object, receive a plurality of reflected light signals in which the plurality of light signals are reflected from the object, generate a plurality of pixel signals based on a plurality of demodulated signals and the plurality of reflected light signals, and generate image data based on the plurality of pixel signals; and
an image processing device configured to perform an operation of processing the image data.

17. The image processing system of claim 16, wherein the plurality of light signals include the same amplitude and period.

18. The image processing system of claim 16, wherein the image sensor generates the plurality of light signals by shifting a phase of a reference light signal at least one time at a regular interval.
